(19) United States
(12) Patent Application Publication
(10) Pub. No.: US 2024/0394742 A1
(43) Pub. Date: Nov. 28, 2024

(54) MERCHANT COMMUNICATIONS, SUCH AS BRANDING COMMUNICATIONS, IN ENVIRONMENTS INCLUDING MORE THAN ONE MERCHANT, AND ESPECIALLY ENVIRONMENTS INCLUDING MORE THAN ONE MERCHANT AND MORE THAN ONE PRODUCTION AND FULFILMENT PROVIDER, SUCH AS MORE THAN ONE PRINT PROVIDER

(71) Applicant: Printify, Inc., Riga (LV)

(72) Inventors: Jose Alberto Vigo Segura, Diemen (NL); Alisa Karpovich, Riga (LV); Juris BRUDNIS, Riga (LV); Juergen Wilhelm Gauger, Bundesrepublik (DE); Aivis Velkeris, Riga (LV); Karlis Kezberis, Riga (LV)

(21) Appl. No.: 18/227,763

(22) Filed: Jul. 28, 2023

Related U.S. Application Data
(60) Provisional application No. 63/468,246, filed on May 22, 2023.

(51) Int. Cl. G06Q 30/0207; G06F 3/12; G06Q 10/0637

(52) U.S. Cl. CPC G06Q 30/0224; G06F 3/1208; G06F 3/1243; G06Q 10/0637

(57) ABSTRACT

In an environment in which merchants lack control of production and fulfillment processes (such as a POD environment), merchants are enabled to personalize the post order customer experience without the need of owning the production and fulfillment process. The potential for mistakes by print providers is reduced.

### § 0. RELATED APPLICATION(S)

This application claims the benefit of U.S. Provisional Application No. 63/468,246 (referred to as “the '246 provisional” and incorporated herein by reference), titled “IMPROVED MERCHANT COMMUNICATIONS, SUCH AS BRANDING COMMUNICATIONS, IN ENVIRONMENTS INCLUDING MORE THAN ONE MERCHANT, AND ESPECIALLY ENVIRONMENTS INCLUDING MORE THAN ONE MERCHANT AND MORE THAN ONE PRODUCTION AND FULFILMENT PROVIDER, SUCH AS MORE THAN ONE PRINT PROVIDER,” filed on May 22, 2023, and listing Jose Alberto Vigo Segura, Alisa Karpovich, Juris Brudnis, Juergen Wilhelm Gauger, Aivis Veļķeris, and Kārlis Ķezberis as the inventors. The scope of the invention is not limited to any requirements of the specific embodiments in the '246 provisional.

### § 1. BACKGROUND OF THE INVENTION

### § 1.1 Field of the Invention

The present description concerns merchant communications, such as branding communications for example. In particular, the present description concerns improving merchant communications in environments including more than one merchant, and especially environments including more than one merchant and more than production and fulfilment provider, such as more than one print provider.

### § 1.2 Background Information

Platforms, such as the one offered by Printify, Inc. of Delaware, having a place of business in Riga, LATVIA (referred to as “Printify”) provide a print-on-demand (“POD”) platform in which various merchants can have their designs printed (or otherwise rendered) on products and shipped by various print providers. It is important for these merchants to build their brand image in order to help deepen their relationships with their customers. More specifically, a key problem for merchants starting in ecommerce is the lack of brand recognition. This lack of brand recognition can lead to a lack of awareness, trust and perceived value in their products. This makes consumers less likely to purchase products from merchants without brand awareness. Building a brand image is a complex journey that ranges from defining the brand value and mission, developing a visual identity with exceptional product descriptions, and engaging with customers.

To engage with customers, merchants have used the post-order experience to create unexpected perks such as, for example, personalized thank you notes, gift messages, and/or discount codes for future purchases. These personalized and individualized experiences are believed to create stronger emotional connections between merchants and their customers, thereby leading to increased customer satisfaction and loyalty. For customers, personalizing the user experience is becoming an expected perk. Many consumers say they expect personalization and many consumers are more likely to make a purchase when brands offer personalized experiences.

U.S. Pat. No. 11,301,925, issued on Apr. 12, 2022, titled “USER INTERFACE FOR PRESENTING PROVIDER INFORMATION TO DESIGNERS AND/OR AUTHORS,” and listing Daniel Marhel, Juris Brudnis, and Vitor Silva as the inventors (referred to as “the '925 patent” and incorporated herein by reference) describes an example POD environment. FIGS. 1A and 1B of the '925 patent illustrate an example environment in which example embodiments consistent with the present description may be used. More specifically, FIG. 1A of the present application is similar to FIG. 1A of the '925 patent, but adds end customers 150. In FIG. 1A of the present application, a hub (also referred to as a “hub entity”) 110 may interact with one or more merchants (e.g., designers and/or authors) 120, one or more print providers 130, one or more online storefronts 140, and one or more end customers 150.

Referring to FIG. 1B of the present application, which is similar to FIG. 1B of the '925 patent, but includes end customers 150, the hub 110 may communicate with each of these entities merchants 120, print providers 130, online storefronts 140, and end customers 150 via one or more networks 160, such as the Internet for example.

Referring to FIG. 2, which is a slightly modified version of FIG. 3 of the '925 patent, in an example implementation by Printify, a print provider 130 may interact with the hub 110 via communications related to a provider information entry user interface. Ultimately, the print provider 130 provides information about itself to the hub 110. A merchant (e.g., designer and/or author) 120 may interact with the hub 110 via communications associated with a physical product selection user interface. For example, the merchant 120 may select a physical product (on which to render its design(s)) and provide that selection to the hub 110. Then, the merchant 120 may further interact with the hub 110 via a print provider selection user interface. The merchant 120 may select one or more physical print providers among those presented. Then, the merchant 120 may further interact with the hub 110 via a product creator user interface. Finally, the merchant 120 may provide information for a product file (or as a product file) to the hub 110.

Still referring to FIG. 2, the hub 110 may provide product file information to an online storefront 140. Although not shown, the hub 110 may also provide product file information to a print provider 130. Alternatively, such product file information may be provided directly from the merchant (e.g., designer and/or author) 120 to the print provider 130. The product file communicated to the print provider 130 and/or the product file communicated to the online storefront 140 may be the same as, or different from, the product file provided from the merchant 120. Further, a product file communicated to the print provider 130 may be different from a product file communicated to the online storefront 140. The various product information files may include subsets of aggregated product information.

When the online storefront 140 receives an order for the product, it may send a product order file to the hub 110. The hub 110 may then send product order information to the print provider 130. Alternatively, when the online storefront 140 receives an order for the product, it may send a product order file to both the hub 110 and directly to the print provider 130. The print provider 130 then arranges for shipment 260 of the ordered product(s) to an end customer 150.

Unfortunately, creating a personalized experience that delights customers and drives repeated purchases is especially difficult for merchants 120 using POD, such as in the example environments of FIGS. 1A and 1B. This difficulty occurs mainly because merchants 120 using POD lack control of production and fulfillment processes at the print provider(s) 130. Moreover, since each print provider 130 will typically handle many merchants 120, a given print provider might have different types of responsibilities for different merchants that it services. Furthermore, it is possible for a given merchant 120 to use more than one print provider 130.

Additionally, it is difficult for these merchants 120 to collect feedback from end customers 150 and use that feedback to improve their products and services. This difficulty arises mainly because merchants 120 using POD cannot easily conduct surveys or questionnaires with the product, asking end customers 150 to rate their experience and provide suggestions for improvement.

Therefore, in the context of an environment in which merchants lack control of production and fulfillment processes (such as a POD environment), it would be useful to enable merchants to maximize their audiences by using merchandise. For example, it would be useful to enable merchants to personalize the post order customer experience without the need of owning the production and fulfillment process. It would be useful to do so in a manner that minimizes the potential for mistakes by print providers.

### § 2. SUMMARY OF THE INVENTION

An example method is provided for use in a system including a plurality of merchants, a hub entity, a plurality of print providers, and a plurality of end customers, such as a POD environment. The example method may provide one or more of the advantages noted above by: (a) receiving, by the hub entity directly or indirectly from one of the plurality of merchants, (1) an identifier of one of the plurality of print providers, (2) a product identifier, (3) a graphic design, and (4) a note design; (b) receiving, by the hub entity, directly or indirectly from one of the plurality of end users, an order for a product identified by the product identifier and including the graphic design; (c) transmitting, from the hub entity directly or indirectly to the one of the plurality of print providers, a printed product order including (1) the product identifier, (2) the graphic design or a unique identifier thereof, and (3) the note design or a unique identifier thereof; (d) printing, by the one of the plurality of print providers, (1) using a first printer, the graphic design on a product identified by the product identifier, to generate a printed product, (2) using a second printer, shipping information associated with the one of the plurality of end users, to generate a printed shipping label, and (3) using a third printer or a different paper source of the second printer, a note using the note design, to generate a printed note; and (e) packaging the printed product and the printed note, thereby defining a packed package, wherein the shipping label is printed on, or affixed to, the packed package. In some example methods may further include initiating shipping to the end customer the packed package.

Another example method is provided for use in a system including a plurality of merchants, a hub entity, a plurality of print providers, and a plurality of end customer, such as a POD environment. The example method may provide one or more of the advantages noted above by: (a) receiving, by the hub entity directly or indirectly from one of the plurality of merchants, (1) an identifier of one of the plurality of print providers, (2) a product identifier, (3) a graphic design, and (4) a note design; (b) receiving, by the one of the plurality of print providers, a printed product order including (1) the product identifier, (2) the graphic design or a unique identifier thereof, and (3) the note design or a unique identifier thereof; (c) printing, by the one of the plurality of print providers and using a first printer, the graphic design on a product identified by the product identifier, to generate a printed product; (d) printing, by the one of the plurality of print providers and responsive to receiving a single a trigger signal (1) using a second printer, shipping information associated with the one of the plurality of end users, to generate a printed shipping label, and (2) using a third printer or a different paper source of the second printer, a note using the note design, to generate a printed note. This example method may further include packaging the printed product and the printed note, thereby defining a packed package, wherein the shipping label is printed on, or affixed to, the packed package. This example method may further include initiating shipping of the packed package.

In some example methods, the single trigger signal is receipt of a scanned code associated with the printed product. In some example methods, the single trigger signal is invoked responsive to the printing, by the one of the plurality of print providers and using a first printer, of the graphic design on a product identified by the product identifier.

In some example methods, each of the shipping label and note include a matching rare design to enable them to be matched using a visual inspection. In some example methods, the matching rare design includes a thumbnail of printed product. In some example methods, the matching rare design includes at least one colored symbol.

In some example methods, the printed note includes a QR code to allow user to (A) leave a review, (B) leave a rating, (C) request a refund, (D) request a return, and/or (E) request a reprint. In some example methods, the printed note includes a name of the end customer to whom the package is being shipped. In some example methods the printed note includes at least one element customized based on a geographic area of end customer to whom the package is being shipped. In some example methods, the printed note includes a voucher. In some example methods, a value or amount of the voucher is determined dynamically.

Yet another example method is provided for use in a system including a plurality of merchants, a hub entity, a plurality of print providers, and a plurality of end customer, such as a POD environment. The example method may include: (a) receiving, by a hub entity directly or indirectly from one of a plurality of merchants, merchant information including (1) a note design or a note design indicator, and (2) a physical product selection input to select one of a plurality of candidate physical products on which to reproduce a graphic design belonging to the merchant, thereby defining a selected physical product; (b) retrieving, using both (1) the physical product selection input and (2) the note design or note design indicator, a set of candidate provider information for each of at least one candidate provider of the selected physical product, wherein the physical product selection input is used to filter candidate providers, wherein the note design or note design indicator is used to filter and/or score candidate providers, and wherein each set of candidate provider information include (1) a minimum price associated with both the candidate provider and the selected physical product, and (2) a candidate provider score; (c) transmitting, from the hub entity to the merchant, the at least one set of candidate provider information retrieved; (d) receiving, by the hub entity directly or indirectly from the merchant, a selection of one of the at least one set of candidate provider information, thereby defining a selected provider; (e) receiving, by the hub entity directly or indirectly from the merchant, the graphic design belonging to the merchant; and (f) generating an order file including (1) the graphic design or an identifier thereof, (2) the physical product selected, (3) the note design or an identifier thereof, (4) the shipping address of an end customer, and (5) an identifier of the one of the plurality of merchants.

Apparatus for performing any of the foregoing methods are also described. Further a non-transitory computer-readable storage medium may be provided for storing processor-executable instructions which, when executed by at least one processor, cause the at least one processor to perform any of the foregoing methods.

### § 3. BRIEF DESCRIPTION OF THE DRAWINGS

FIGS. 1A and 1B illustrate an example environment in which example embodiments consistent with the present description may be used.

FIG. 2 illustrates example communications between entities in the example environment of FIGS. 1A and 1B.

FIGS. 3A and 3B illustrate example hub operations and example print provider operations, respectively, for use in an environment such as that illustrated in FIGS. 1A and 1B.

FIGS. 4A and 4B illustrate example hub operations and example print provider operations, respectively, for use in an environment such as that illustrated in FIGS. 1A and 1B.

FIGS. 5A and 5B illustrate example hub operations and example merchant operations, respectively, for use in an environment such as that illustrated in FIGS. 1A and 1B.

FIGS. 6-9 illustrate example user interface screens for a merchant to create and add a branding element, such as a note for example.

FIG. 10 illustrates an example user interface for a merchant to filter candidate print providers based on whether or not they support merchant branding.

FIG. 11 illustrates an example hub server(s) consistent with the present description.

FIG. 12 is a block diagram of an example processor-based system that may be used to execute the example methods and/or to store information used and/or generated by such example methods.

### § 4. DETAILED DESCRIPTION

The present description may involve novel methods, apparatus, message formats, data structures, and/or user interfaces for enabling merchants to personalize the post-order customer experience without the need of owning the production and fulfillment process (for example, in the context of an environment in which merchants lack control of production and fulfillment processes, such as a POD environment. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

### § 4.1 Example Environment

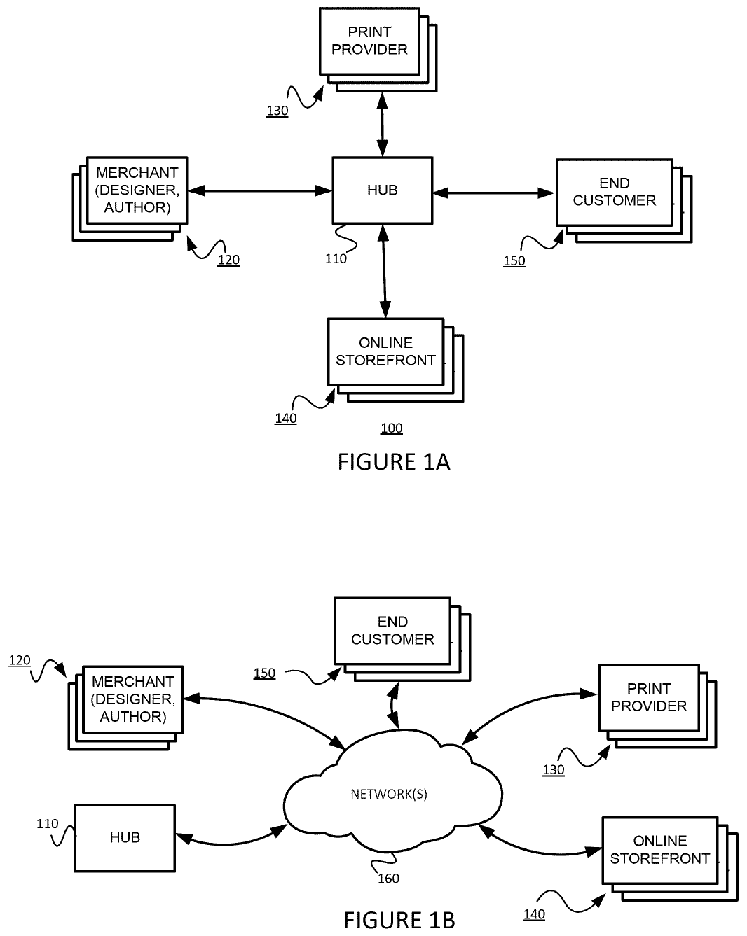

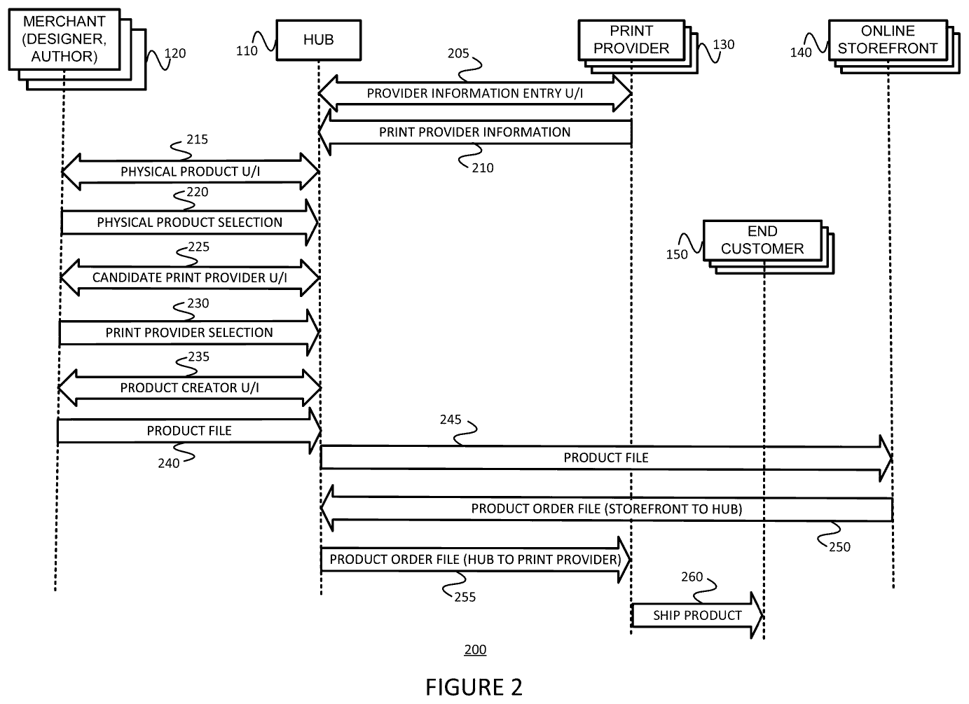

Example embodiments consistent with the present description may be implemented in a POD system, such as the one 100 illustrated in FIG. 1B. FIG. 2 illustrates communications among various parts of the example system 100 of FIGS. 1A and 1B. As discussed above, a print prover 130 may interact with the hub 110 via communications 205 related to a provider information entry user interface. Ultimately, the print provider 130 provides information about itself to the hub 110 via communication(s) 210.

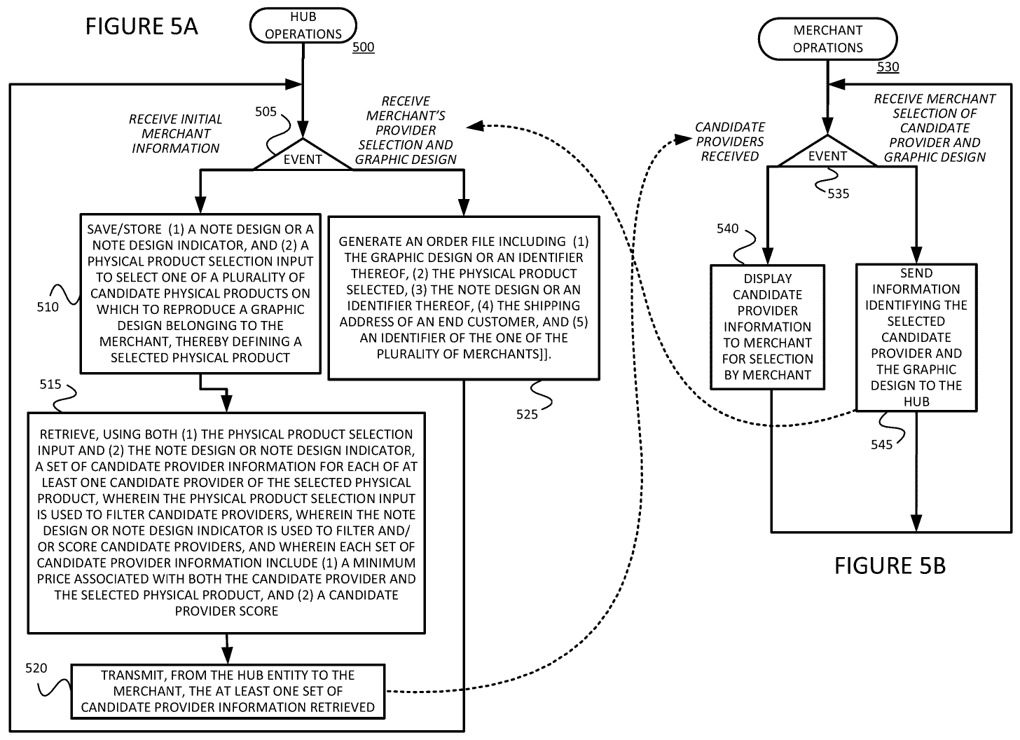

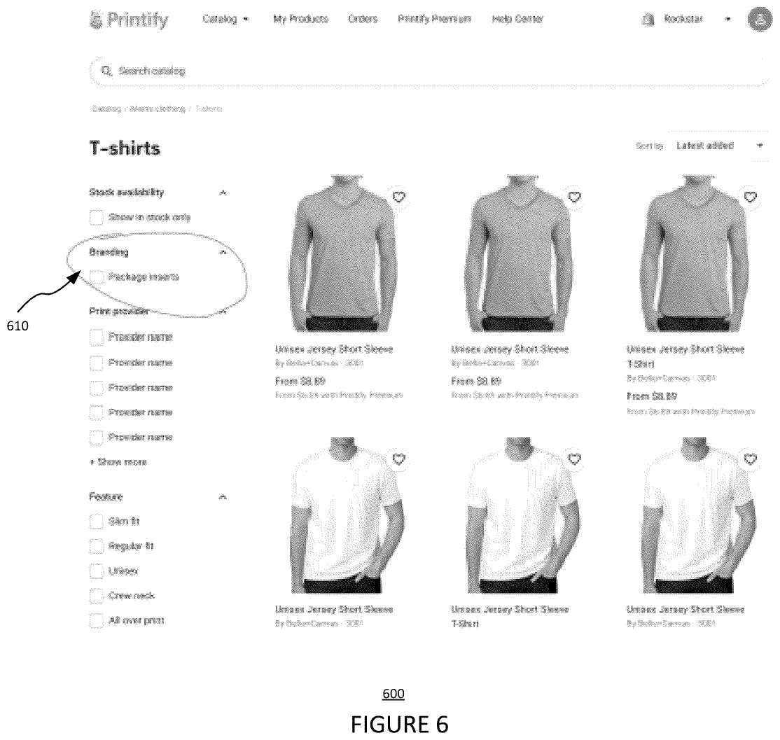

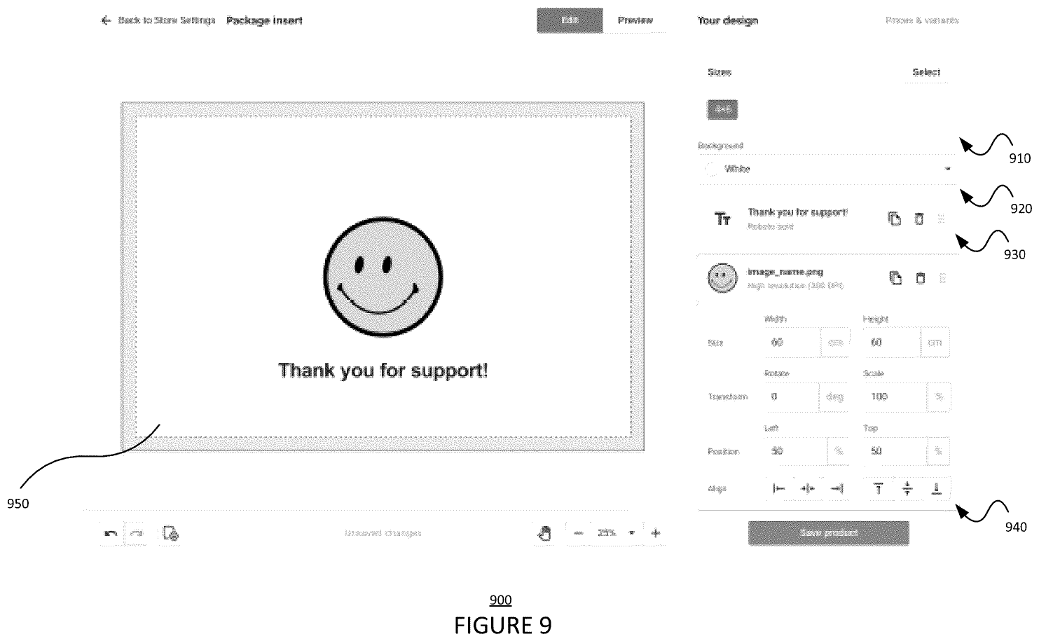

Still referring to FIG. 2, as discussed above, a merchant (e.g., designer and/or author) 120 may interact with the hub 110 via communications 215 associated with a physical product selection user interface. An example of such a user interface is described in the '925 patent with reference to FIG. 5 of the '925 patent. The merchant 120 may select a physical product (on which to render its design(s)) to the hub 110 via communication(s) 220. Then, the merchant 120 may further interact with the hub 110 via communications 225 associated with a print provider selection user interface. An example of such a user interface is described in the '925 patent with reference to FIG. 6 (which includes FIGS. 6A-6E) of the '925 patent. The merchant 120 may select a physical print provider among those presented via communications 230. Then, the merchant 120 may further interact with the hub 110 via communications 235 associated with a product creator user interface. An example of such a user interface is described in the '925 patent with reference to FIGS. 9A and 9B. Finally, the merchant 120 may provide information for a product file (or as a product file) to the hub 110 via communication(s) 240.

Still referring to FIG. 2, as discussed above, the hub 110 may provide product file information to an online storefront 140 via communication(s) 245. Although not shown, the hub 110 may also provide product file information to a print provider 130. Alternatively, such product file information may be provided directly from the merchant (e.g., designer and/or author) 120. The product file communicated to the print provider 130 and/or the product file communicated to the online storefront 140 may be the same as, or different from, the product file provided from the merchant 120. Further, a product file communicated to the print provider 130 may be different from a product file communicated to the online storefront 140. The various product information files may include subsets of aggregated product information.

As discussed above, when the online storefront 140 receives an order for the product, it may send a product order file (storefront to hub) to the hub 110 via communication 250. The hub 110 may then send product order information (hub to print provider) to the print provider 130 via communication 255. Alternatively, when the online storefront 140 receives an order for the product, it may send a product order file to both the hub 110 and directly to the print provider 130. Although not shown, one or more order status notifications (e.g., order receipt, order fulfillment, order shipping, etc.) may be provided to the merchant 120, either directly from the online storefront 140 and/or the print provider 130, or indirectly via the hub 110.

### § 4.2 Example Methods

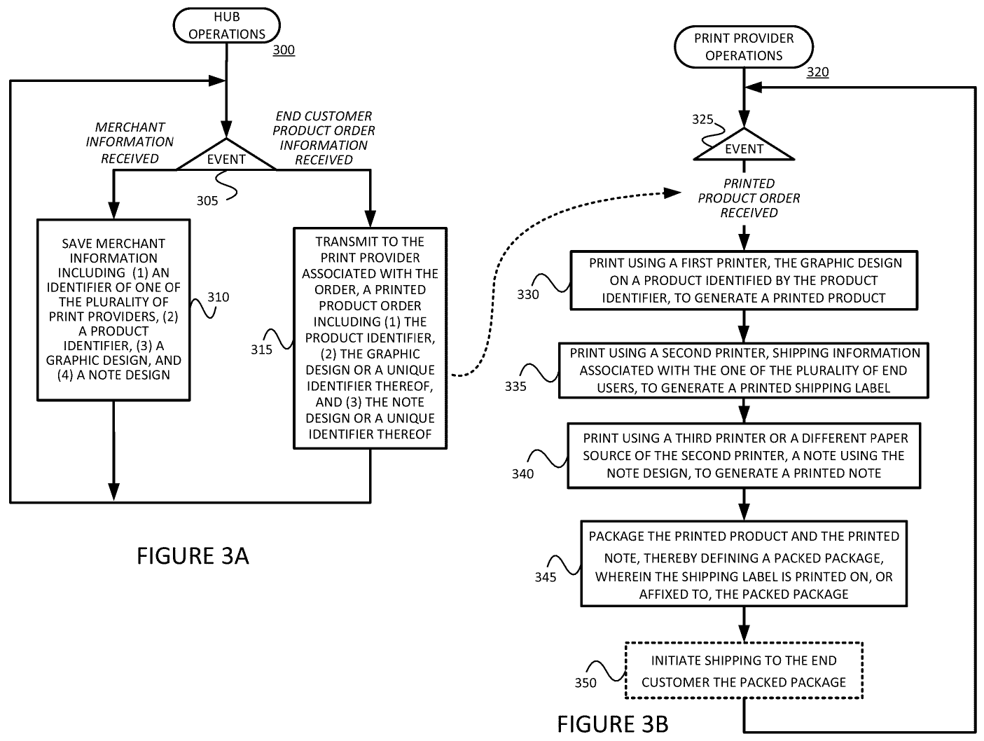

FIGS. 3A and 3B illustrate example hub operations 300 and print provider operations 320, respectively, for use in a system including a plurality of merchants, a hub entity, a plurality of print providers, and a plurality of end customers. Referring first to FIG. 3A, various branches of the hub operations 300 are performed responsive to the occurrence of different events 305. For example, the left branch of example operations 300 is performed responsive to the hub 110 receiving (directly or indirectly) from one of the plurality of merchants, (1) an identifier of one of the plurality of print providers (Recall, e.g., 225 of FIG. 2.), (2) a product identifier (Recall, e.g., 220 of FIG. 2.), (3) a graphic design (Recall, e.g., 235 of FIG. 2.), and (4) a note design. The information received is saved or stored on a computer-readable storage medium. (Block 310) Referring back to event 305, the right branch of example operations 300 is performed responsive to the hub 110 receiving (directly or indirectly) from one of the plurality of end customers 150, an order for a product identified by the product identifier and including the graphic design. In response, the example operations 300 transmit, from the hub entity (directly or indirectly) to the one of the plurality of print providers, a printed product order including (1) the product identifier, (2) the graphic design or a unique identifier thereof, and (3) the note design or a unique identifier thereof. (Recall, e.g., 255 of FIG. 2.)

Referring to FIG. 3B, responsive to receiving a printed product order (main branch from Event 325), the example operations 320 performed by an appropriate of the one of the plurality of print providers, print (1) using a first printer, the graphic design on a product identified by the product identifier, to generate a printed product (Block 330), (2) using a second printer, shipping information associated with the one of the plurality of end users, to generate a printed shipping label (Block 335), and (3) using a third printer or a different paper source of the second printer, a note using the note design, to generate a printed note (Block 340). The example operations 320 then package the printed product and the printed note, thereby defining a packed package, wherein the shipping label is (or was) printed on, or affixed to, the packed package. (Block 345)

The example operations 320 may then initiating shipping to the end customer 150, the packed package. (Block 350) (Recall 260 of FIG. 2.) Although block 350 is illustrated as a print provider operation, this may be outsourced to an entity other than the print provider. In any event, “initiate shipping by the print provider” is intended to be interpreted broadly to include either case.

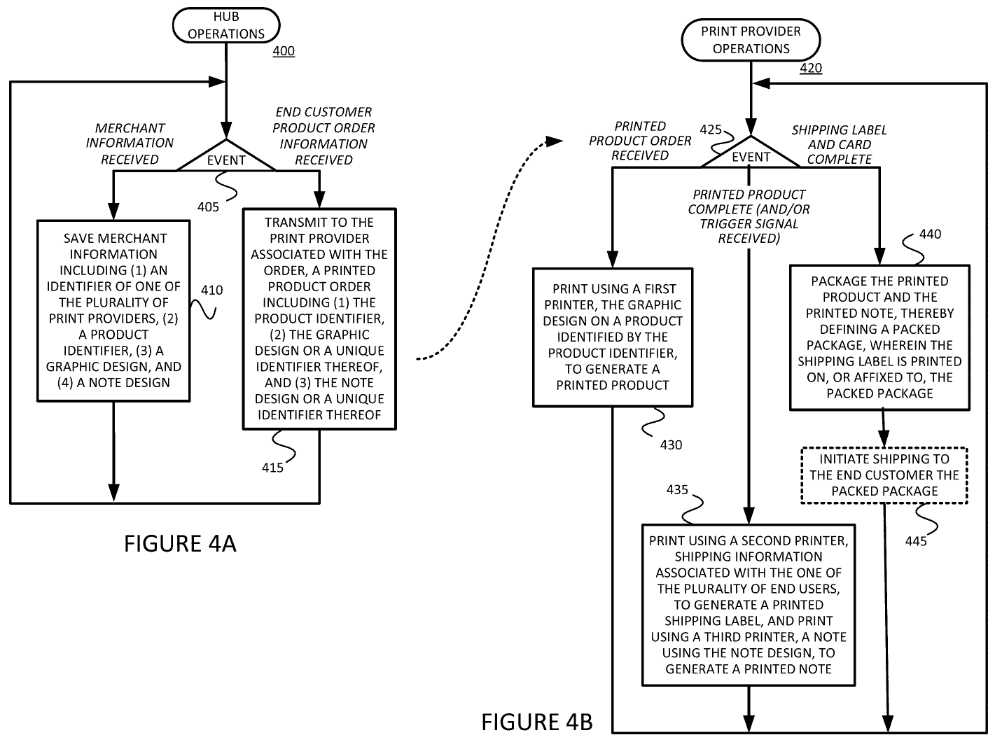

As noted above, it is desired to reduce or minimize the potential for errors by the print provider. For example, since a given print provider might handle multiple merchants, there is a chance for not providing a merchant note, or for providing a note from the wrong merchant. FIGS. 4A and 4B illustrate alternative example hub operations 400 and print provider operations 420, respectively, for use in a system including a plurality of merchants, a hub entity, a plurality of print providers, and a plurality of end customers. Referring first to FIG. 4A, various branches of the hub operations 400 are performed responsive to the occurrence of different events 405. For example, the left branch of example operations 400 is performed responsive to receiving, by the hub entity (directly or indirectly) from one of the plurality of merchants, (1) an identifier of one of the plurality of print providers, (2) a product identifier, (3) a graphic design, and (4) a note design. The information received is saved or stored on a computer-readable storage medium. (Block 410) Referring back to event 405, the right branch of example operations 400 is performed responsive to the hub 110 receiving (directly or indirectly) from one of the plurality of end customers 150, an order for a product identified by the product identifier and including the graphic design. In response, the example operations 400 transmit, from the hub entity (directly or indirectly) to the one of the plurality of print providers, a printed product order including (1) the product identifier, (2) the graphic design or a unique identifier thereof, and (3) the note design or a unique identifier thereof.

Referring to FIG. 4B, different branches of the example print provider operations 420 are performed in response to the occurrence of different events. (Event branch point 425). For example, referring to the left branch of FIG. 4B, responsive to receiving a printed product order, the example operations 420 performed by an appropriate of the one of the plurality of print providers, prints using a first printer, the graphic design on a product identified by the product identifier, to generate a printed product. (Block 430)

Referring next to the center branch of FIG. 4B, responsive to the occurrence of a trigger event (e.g., the printed product being complete and perhaps one or more further conditions), the example operations 420 print (1) using a second printer, shipping information associated with the one of the plurality of end users, to generate a printed shipping label, and (2) using a third printer (or a different paper source of the second printer), a note using the note design, to generate a printed note. (Block 435)

Referring next to the right branch of FIG. 4B, responsive to the completion of the printing of the shipping label and the printed note, the example operations 420 may further include packaging the printed product and the printed note, thereby defining a packed package. Note that the shipping label is printed on, or affixed to, the packed package. (Block 440) The example operations 420 may further include initiating shipping the packed package. (Block 445) Although block 445 is illustrated as a print provider operation, this may be outsourced to an entity other than the print provider. In any event, “initiate shipping by the print provider” is intended to be interpreted broadly to include either case.

Still referring to FIG. 4B, in some example implementations, a single trigger signal, responsive to which the middle branch is performed, is receipt of a scanned code associated with the printed product. In other example implementations, a single trigger signal, responsive to which the middle branch is performed, is invoked responsive to the printing, by the one of the plurality of print providers and using a first printer, of the graphic design on a product identified by the product identifier.

Referring back to FIG. 4B, although the use of a (e.g., single) trigger signal helps to avoid note-package mismatches, other safeguards may be used instead, or in addition. For example, the note (in any of the example implementations) may include a thumbnail of the printed product, a unique or rare identifier (e.g., numeric, alphabetic, alphanumeric, symbol(s), colored symbols, or any combination of the foregoing) with a matching unique or rare identifier on the on the shipping label (or on the printed product, or on a tag with the printed product, etc.) to help ensure the proper note is placed in the proper package. For example, the card and shipping label may be printed to include a matching unique (or rare at given space/time) ID, a matching unique (or rare at given space/time) symbol/color combination (e.g., red diamond, green triangle, purple crescent, . . . ), printed product thumbnail, etc.

Note that the example operations 300 and 320 (and similarly operations 400 and 420) collectively enable merchants to personalize the post order customer experience without the need of owning the production and fulfillment process, such as in the context of an environment in which merchants lack control of production and fulfillment processes (such as a POD environment). These operations do so in a way that is not overly burdensome the party in control of the production and fulfillment processes, such as print providers for example. Operations may be synchronized to minimize the likelihood of packaging the merchant note in the wrong package, and/or failing to package the merchant note. Referring back to FIG. 4B, the use of a (e.g., single) trigger signal helps to avoid note-package mismatches.

As described above with reference to FIG. 2, after the merchant 120 selects a physical product (on which to render its design(s)) via communications 215/220, the merchant 120 may then further interact with the hub 110 via communications 225 associated with a print provider selection user interface. An example of such a user interface is described in the '925 patent with reference to FIG. 6 (which includes FIGS. 6A-6E) of the '925 patent. The merchant 120 may select a physical print provider among those presented via communications 230. Note that some example implementations consistent with the present description may be used to score and/or filter candidate print providers 130 presented for selection to the merchant 120 using their willingness and ability to package a merchant note (or otherwise offer merchant branding services). FIGS. 5A and 5B are flow diagrams of example hub operations 500 and merchant operations 530, respectively, that may be used to score and/or filter candidate print providers 130 in this way.

Referring first to FIG. 5A, different branches of example operations 500 may be performed responsive to the occurrence of different events. (Event branch point 505) More specifically, the left branch of example operations 500 is performed in response to receiving initial merchant information (such as, for example, a physical product selection on which they wish to sell their design, whether or not they want the print provider to perform merchant branding functions such as inserting a merchant card in the packaged product, etc.). For example, responsive to receiving (directly or indirectly) from one of a plurality of merchants, merchant information including (1) a note design or a note design indicator, and (2) a physical product selection input to select one of a plurality of candidate physical products on which to reproduce a graphic design belonging to the merchant, thereby defining a selected physical product, the example operations 500 saves or otherwise stores the received information (Block 510) and retrieves, using both (1) the physical product selection input and (2) the note design or note design indicator, a set of candidate provider information for each of at least one candidate provider of the selected physical product, wherein the physical product selection input is used to filter candidate providers, and wherein the note design or note design indicator is used to filter and/or score candidate providers. (Block 515). In some implementations, each set of candidate provider information includes (1) a minimum price associated with both the candidate provider and the selected physical product, and (2) a candidate provider score. The at least one set of candidate provider information retrieved is then transmitted from the hub entity to the merchant. (Block 520)

Referring FIG. 5B, different branches of example operations 530 may be performed responsive to the occurrence of different events. (Event branch point 535) More specifically, the left branch of example operations 530 is performed in response to receiving (directly or indirectly) from the hub, at least one set of candidate provider information. (Recall block 520) In response, this information (or a subset thereof, or information derived therefrom) is presented (e.g., displayed) to the merchant. (Block 540) The right branch of example operations 530 is performed in response to receiving a selection of one of the at least one set of candidate provider information, thereby defining a selected provider. In response, the example operations 530 send information identifying the selected candidate print provider (and the graphic design to be printed on the product) to the hub. (Block 545)

Referring again to FIG. 5A, the right branch of operations 500 is performed responsive to receiving (directly or indirectly) from the merchant the selected print provider and the graphic design belonging to the merchant. In response, the example operations 500 generate an order file including the graphic design or an identifier thereof, the physical product selected, the note design or an identifier thereof, the shipping address of an end customer, and an identifier of the one of the plurality of merchants. (Block 525)

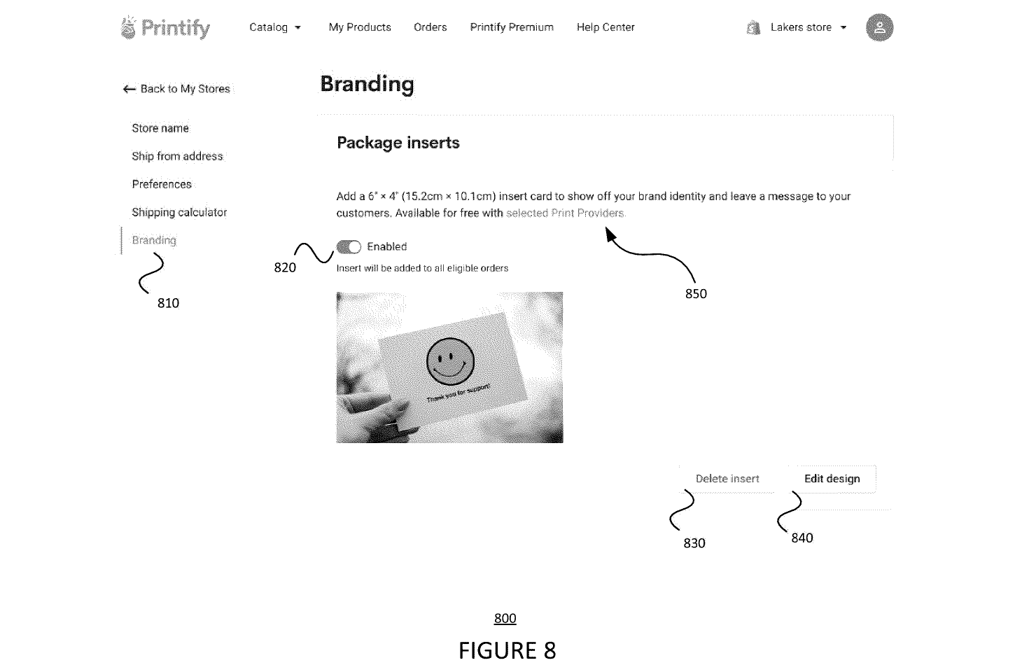

As should be appreciated from the foregoing, example operations consistent with those in FIGS. 5A and 5B may be used to filter and/or score print providers (to be selected by the merchant) depending on whether or not the print provider supports merchant branding (for example, whether or not the print provider supports printing and packaging thank you notes). In the context of scoring candidate print providers, whether or not the print provider offers merchant branding can be used alone, or together with scoring factors and methods described in § 4.2.1 and FIG. 8 of the '925 patent. In some example implementations, a print provider filtered out as a candidate because they don't offer a branding element desired by the merchant can be informed of this (or statics of lost opportunities) in order to incentivize them to offer the desired branding.

### § 4.3 Example User Interface Screens

FIGS. 6-9 illustrate example user interface (UI) screens for a merchant to create and add a branding element, such as a note for example. Referring first to example UI screen 600 of FIG. 6, note that when a merchant selects a product category such as T-shirts for example, they might be presented with a checkbox 610 through which they can indicate their desire to use branding, such as packaging a note with T-shirts printed with their design(s).

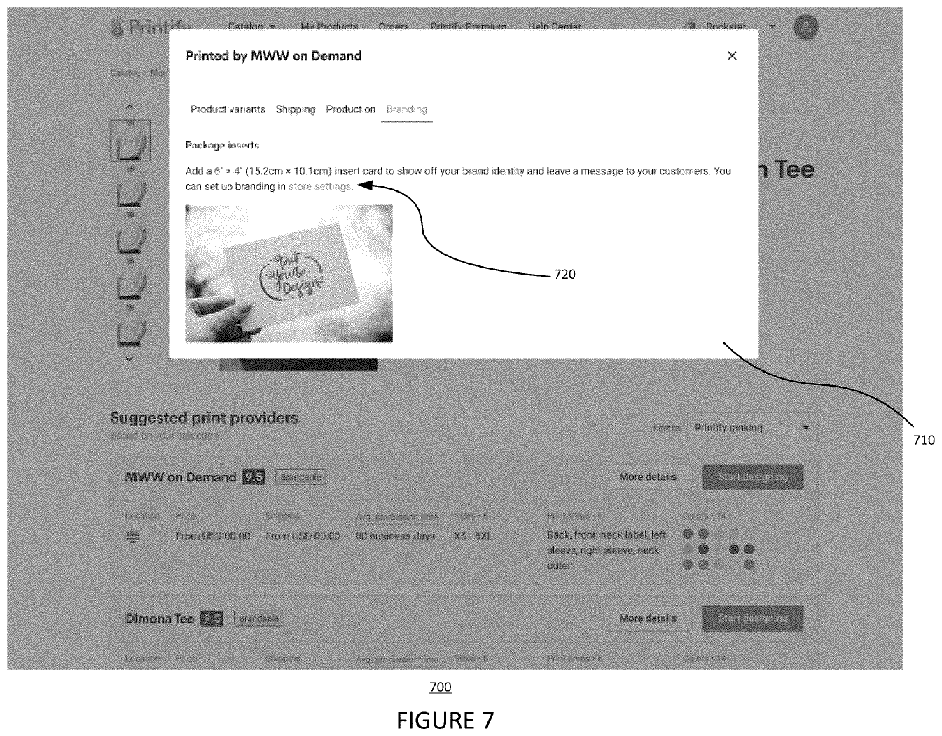

The example UI screen 700 of FIG. 7 includes a pop-up window 710 describing branding using an insert card and a hypertext link 720 allowing the merchant to set up branding. Assume that the merchant selects (e.g., clicks on) the hypertext link 720. In response, example UI screen 800 of FIG. 8 is presented to the merchant. The example UI screen 800 includes selectable hypertext in the left column. It is assumed that the “Branding” hypertext 810 has been selected. A merchant can use widget 820 to enable or disable branding. The merchant can delete or edit the design of an insert using buttons 830 and 840, respectively.

Assume that the merchant wants to create or edit an insert note design. FIG. 9 illustrates an example UI screen 900 to allow the merchant to create or edit their note. The example UI screen 900 includes an area 910 for selecting (or otherwise defining) the size of the insert note, an area 920 for selecting (or otherwise defining) a background color (and/or pattern, etc.) of the insert note, an area 930 for adding text and selecting (or otherwise defining) a font for the text of the insert note, and an area 940 for providing and editing (e.g., in terms of size, position, etc.) an image to be used on the insert note. Area 950 of the example UI 900 provides a WYSIWYG display of the insert note with the current design elements. The insert note can be saved.

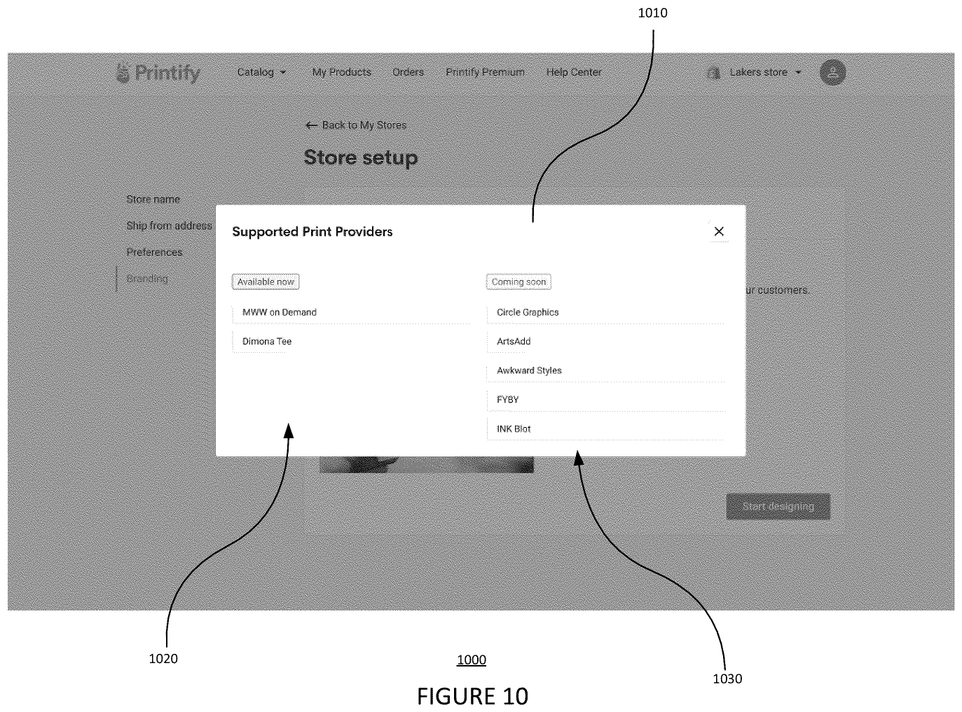

Referring back to FIG. 8, the example UI screen 800 includes hypertext 850 for allowing the merchant to see which print providers support the type of branding (e.g., insert notes) that they want. FIG. 10 illustrates an example UI screen 1000 for a merchant to filter candidate print providers based on whether or not they support branding. In this case, the example UI screen 1000 includes a pop-up window 1010 including a list 1020 of print providers that support the branding desired by the merchant. (Recall, for example, blocks 515, 520 and 540 of FIGS. 5A and 5B.) The pop-up window 1010 may also include a list 1030 of print providers that will soon support the branding desired by the merchant.

### § 4.4 Example Apparatus

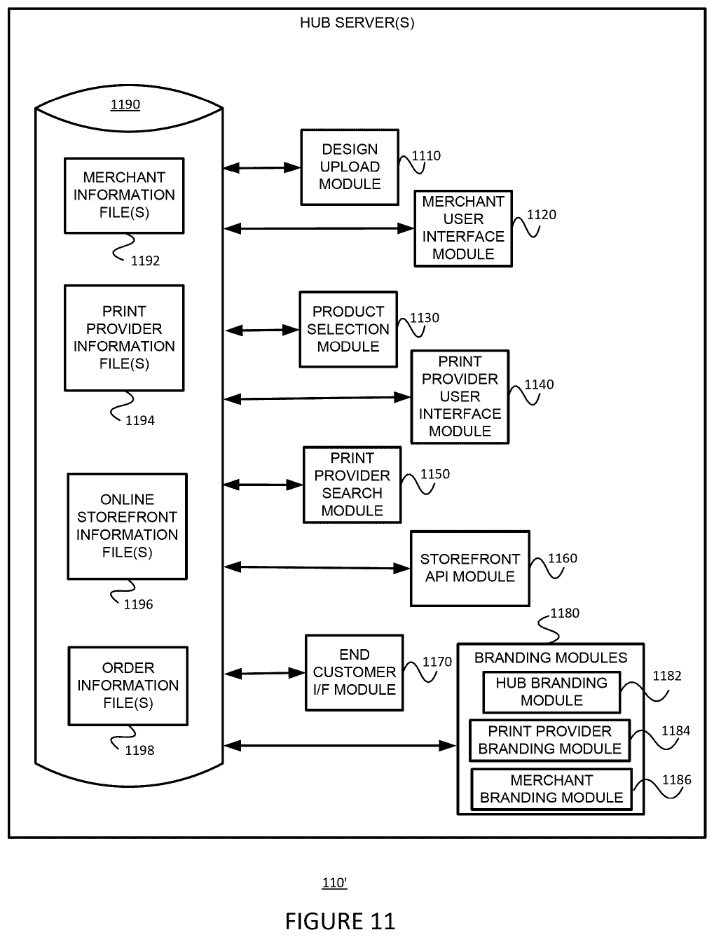

FIG. 11 illustrates an example hub server(s) 110′ consistent with the present description. As shown, the example hub server(s) 110′ may include a design upload module 1110, a merchant (e.g., a designer and/or an author) user interface module 1120, a product selection module 1130, a print provider user interface module 1140, a print provider search module 1150, a storefront application program interface (API) module 1160, an end customer interface module 1170, branding modules 1180, and various stored information 1190. The various stored information 1190 may include merchant information files 1192, print provider information files 1194, online storefront information files 1196 and order information files 1198. The branding modules 1180 may include a hub branding module 1182, a print provider branding module 1184 and a merchant branding module 1186. Examples of some of the operations performed by the hub branding module 1182 were described above with reference to FIGS. 3A, 4A and 5A. Examples of some of the operations performed by the print provider branding module 1184 were described above with reference to FIGS. 3B and 4B. Finally, examples of some of the operations performed by the merchant branding module 1186 were described above with reference to FIG. 5B. The merchant user interface module 1120 may provide UI screens such as those described with reference to FIGS. 6-9. The print provider search module may include operations such as some of the blocks in FIGS. 5A and 5B.

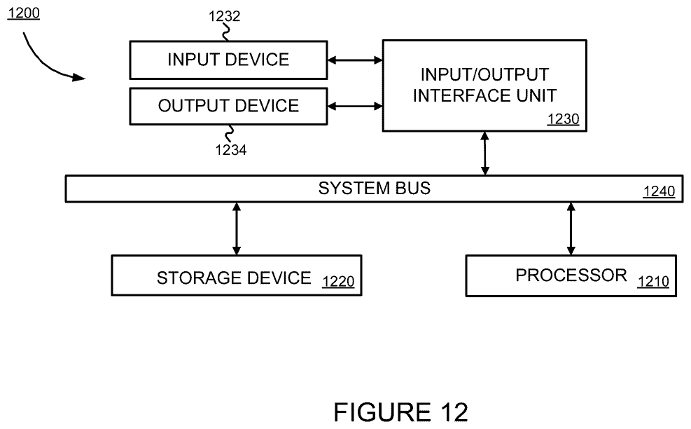

FIG. 12 is a block diagram of an exemplary machine 1200 that may perform one or more of the methods (e.g., 300, 320, 400, 420, 500 and 530) described, and/or store information used and/or generated by such methods. The exemplary machine 1200 includes one or more processors 1210, one or more input/output interface units 1230, one or more storage devices 1220, and one or more system buses and/or networks 1240 for facilitating the communication of information among the coupled elements. One or more input devices 1232 and one or more output devices 1234 may be coupled with the one or more input/output interfaces 1230. The one or more processors 1210 may execute machine-executable instructions (e.g., C or C++ running on the Linux operating system widely available from a number of vendors) to effect one or more aspects of the present disclosure. At least a portion of the machine executable instructions may be stored (temporarily or more permanently) on the one or more storage devices 1220 and/or may be received from an external source via one or more input interface units 1230. The machine executable instructions may be stored as various software modules, each module performing one or more operations. Functional software modules are examples of components which may be used in the apparatus described.

In some embodiments consistent with the present disclosure, the processors 1210 may be one or more microprocessors and/or ASICs. The bus 1240 may include a system bus, one or more networks (e.g., LANs), etc. The storage devices 1220 may include system memory, such as read only memory (ROM) and/or random access memory (RAM). The storage devices 1220 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present disclosure may also be provided as a machine-readable medium for storing the machine-executable instructions. The machine-readable medium may be non-transitory and may include, but is not limited to, flash memory, optical disks, CD-ROMs, DVD ROMs, RAMS, EPROMs, EEPROMs, magnetic or optical cards or any other type of machine-readable media suitable for storing electronic instructions. For example, example embodiments consistent with the present disclosure may be downloaded as a computer program, which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present disclosure (or components or modules thereof) might be implemented in hardware, such as one or more field programmable gate arrays (“FPGA”s), one or more integrated circuits such as ASICs, etc. Alternatively, or in addition, embodiments consistent with the present disclosure (or components or modules thereof) might be implemented as stored program instructions executed by a processor. Such hardware and/or software might be provided a laptop computer, desktop computer, a tablet computer, a mobile phone, etc.

### § 4.5 Illustrative Operational Example

In one example implementation, the process starts with the merchants who will create or upload their designs for a custom package insert to their POD store. When an order is placed that requires an insert to be printed, the information on the insert will be sent to the print provider via an API along with all of the other relevant information regarding that order (for example,

```
{
    “id”: “6467672cccce3e238c0add4d”,
    “address_to”: {
      “address1”: “43 speldhurst road”,
      “address2”: “”,
      “city”: “London”,
      “zip”: “W4 1BX”,
      “country”: “GB”,
      “region”: “ENG”,
      “first_name”: “Daniela”,
      “last_name”: “France”,
      “email”: “dfaustini2000@yahoo.co.uk”,
      “phone”: “0000000”
    },
    “address_from”: {
      “address1”: “Grenzstraβe 15”,
      “address2”: “Smart Logistic Services”,
      “city”: “Halle”,
      “zip”: “06112”,
      “country”: “US”,
      “region”: “CA”,
      “company”: “XpressYourselfNow”,
      “email”: “”,
      “phone”: “”
    },
    “shipping”: {
      “carrier”: “DEFAULT”,
      “priority”: “some_priority”
    },
    “items”: [
      {
        “sku”: “product-sku”,
        “preview_files”: {
          “front”: “https://images.printify.com/order-
mockup/productid/vid/oid/arctic-monkee-no-text-tee.jpg?camera_label=front”
        },
        “print_files”: {
          “front”: “https://images.printify.com/print/productid/vid/front/my-
print.png”
        },
        “quantity”: 1,
        “id”: “vd”,
        “options”: {
          “front”: {
            “underbase”: true
          }
        }
      }
    ],
    “package_inserts”: [
      {
        “url”: “https://images.printify.com/branding-insert/insertid/print/file.pdf”
      }
    ]
  }
```

where:
   “id” is a unique string identifier for the order. Each ID is unique across the system. This may be used to locate the order and the order with branding.
   “address to” is the delivery address for the order. It need not be specifically tied to the branding, but is an integral part of every order and branding can be part of each of those orders.
   “address from” is the address of the print provider facility, or proxy shipping service for the print provider. This address may be used for potential returns.
   “shipping” indicates to the print provider which shipping method to use.
   “items” is the individual products (line items) to be printed and shipped to the customer.
   “package inserts” informs the print provider that the order contains a package (e.g., branding) insert(s) and identifies (e.g., via a URL) from where to download the print file.
      Details of an Example Production API that May be Used are Provided in Appendix A.

Once the product of the respective order is printed and moved to the packing station for packaging, the operator or packing machine will scan the order's barcode. Normally, this triggers the printing of the shipping label for an order, but in this example, it will also trigger the printing of the accompanying insert if it is included with the order made. The operator or packing machine then places the printed insert along with the product in the package, closes the package and applies the shipping label.

### § 4.6 Refinements, Alternatives, and Extensions

In some example implementations consistent with the present description, a QR code is provided on part of printed note to allow end customers 150 to leave a review and/or rating, request a refund, return, or reprint. This also serves as an acknowledgment that the end customer actually received the (hopefully, though not necessarily, correct) thank you card.

In some example implementations consistent with the present description, the printed note is personalized. This may be done using one or more of the following. The printed note may be customized with the end customer's name. The printed note may be customized using the geographic area of the end customer and/or using most prevalent language in geographic area of the end customer. In such embodiments, one or more elements of the printed note are fixed, based on elements entered by the merchant, while one or more other elements of the printed note are determined dynamically (e.g., based on one or more aspects of the order, such as customer name, customer location, specific one of the merchant's designed printed on the product, date and/or time the order was placed, date and/or time the order was shipped, etc.)

Some example implementations consistent with the present description batch runs for a given merchant to reduce risk of mismatched product and printed note.

Some example implementations consistent with the present description use the same printer and/or paper for notes across all print providers for standardized note.

In some example implementations consistent with the present description, the printed note is (or includes) a coupon or voucher. In some example implementations, the coupon voucher itself, or the value or amount of the coupon or voucher, is conditional, or determined dynamically (e.g., conditioned to promote to a high volume end customer, conditioned to promote within a geographic region, etc.)

In yet other example implementations, instead of or in addition to a printed note or insert, the branding element can be something printed directly on the product, such as on the sleeve of a shirt, inside the neck of a shirt (e.g., a neck label), etc.

Although the shipping label and note may be printed on different printers, they can be printed on different paper sources from the same printer. Alternatively, a single paper source can be used if each sheet has a first section or area for the shipping label and a second section or area for the note, wherein the first and second sections can be separated.

Although some example embodiments were described in the context of print providers, such embodiments can be applied to systems using other production and fulfilment providers.

### § 4.7 Conclusions

Using example embodiments consistent with the present description, merchants can easily create and add branding options to their products and packages with minimum effort and without significantly affecting their margins. Further, example embodiments consistent with the present description help production and fulfillment providers, such as print providers for example, to easily provide branding elements and reduce the chance for mismatching a branding element with the wrong merchant shipment.

### Appendix A

### Production API

The Production API is used by the hub to submit an order to be fulfilled by the Print Provider. The Print Provider receives an order request, accepts or rejects it, and if accepted proceeds with actual production and shipment of the order.

### Top-Level Properties

idREAD-ONLY A unique string identifier for the Hub order. Each ID is unique across the Hub system. “id”: “5cb87a8cd490a2ccb256cec4”
reference_idREQUIRED* A unique string identifier for the Hub order in the Print Provider system. “reference_id”: “1133456”
This field appears only in the response body of the GET/v2019-06/orders/{HUB-ID}.json sample OPTIONAL Optional boolean indicating if this is a sample order. “sample”: true
This field appears only in the request body of the GET/v2019-06/orders/{HUB-ID}.json reprint OPTIONAL Optional boolean indicating if this is a reprint order. “reprint”: true
This field appears only in the request body of the GET/v2019-06/orders/{HUB-ID}.json xqc OPTIONAL Optional boolean indicating if this order is eligible for an extra Quality Care.

The particular details what it entails are explained in business agreement signed by both parties (Hub and Print Provider). “xqc”: true

This field appears only in the request body of the GET/v2019-06/orders/{HUB-ID}.json
address_to REQUIRED Address to ship an order to. “address_to”: {“address1”: “1234 address1 line”, “address2”: “ ”, “city”: “EXAMPLE”, “zip”: “31345”, “country”: “US”, “region”: “NY”, “company”: “T-Shirt Company #1”, “first_name”: “john”, “last_name”: “smith”, “email”: “john.smith@example.com”, “phone”: “3312312231”} See address_to properties for reference.
address_from REQUIRED Address to return an order to, in case of issues with shipping. “address_from”: {“address1”: “1234 address1 line”, “address2”: “ ”, “city”: “EXAMPLE”, “zip”: “31345”, “country”: “US”, “region”: “NY”, “company”: “T-Shirt Company #1”, “email”: “company@example.com”, “phone”: “6512312231”} See address_from properties for reference.
shipping REQUIRED Shipping carrier configuration. “shipping”: {“carrier”: “UPS”, “priority”: “express”} See shipping properties for reference.
package_inserts NEW*OPTIONAL Package Inserts “package_inserts”: [{“url”:
“https://images.printify.com/storage/package-insert-1.pdf”}, {“url”:
“https://images.printify.com/storage/package-insert-2.pdf”}] See package_inserts properties for reference.
items REQUIRED Individual products (line items) to be printed and shipped to the customer.
“items”: [{“id”: “62990be2d0827d94be27ba6b”, “sku”: “3001-BLACK-L”, “preview_files”: {“front”:
“https://images.printify.com/mockup/front-url.jpeg”, “back”:
“https://images.printify.com/mockup/back-url.jpeg”}, “print_files”: {“front”:
“https://images.printify.com/print/front-url.jpeg”, “back”:
“https://images.printify.com/print/back-url.jpeg”, “left_sleeve”:
“https://images.printify.com/print/left_sleeve-url.jpeg”}, “quantity”: 1}, {“id”:
“62990bebad471213f4276ab5”, “sku”: “3000-RED-L”, “preview_files”: {“front”:
“https://images.printify.com/mockup/front-url.jpeg”, “back”:
“https://images.printify.com/mockup/back-url.jpeg”}, “print_files”: {“front”:
“https://images.printify.com/print/front-url.jpeg”}, “quantity”: 1}] See items properties for reference.
tags OPTIONAL An array of tags to apply for an order. “tags”: [“prioritised”, “sample”, “reprint”] See order tags for reference.
address_to properties
address1REQUIRED First line of destination post address.
address2REQUIRED Second line of destination post address. Contains suite, apartment number, etc. May be sent as an empty string.
cityREQUIRED Destination city name
zipREQUIRED Destination ZIP code. If the destination country does not use ZIP codes it will be set to “00000”.
countryREQUIRED Destination country code. ISO 3166 country codes are used.
regionOPTIONAL Destination state code. ISO 3166 state codes are used for the United States, and for other countries the region name will be used.
companyOPTIONAL Name of business to receive package
first_nameREQUIRED First name of package receiver.
last_nameREQUIRED Last name of package receiver.
emailOPTIONAL Email of package receiver.
phoneOPTIONAL Phone number of package receiver.
address_from properties
address1REQUIRED First line of return post address.
address2REQUIRED Second line of return post address. Contains suite, apartment number, etc. May be sent as an empty string.
cityREQUIRED Return city name
zipREQUIRED Return ZIP code. If the destination country does not use ZIP codes it will be set to “00000”.
countryREQUIRED Return country code. ISO 3166 country codes are used.
regionOPTIONAL Return state code. ISO 3166 state codes are used for the United States, and for other countries the region name will be used.
companyREQUIRED Name of business for return address.
emailOPTIONAL Email of the seller for return address.
phoneOPTIONAL Phone number of the seller for return address.
shipping properties
carrierREQUIRED Carrier name used for sending the package.
priorityREQUIRED Priority class of the shipment. Example: “express” or “standard” package_inserts properties NEW*
urlREQUIRED URL indicating to a document resource for package insert. Custom branding empowers customers with option to include thank-you notes/coupons in their orders.
items properties
idREQUIRED ID of the line item for reference.
skuREQUIRED SKU (stock keeping unit) that represents what kind of product and variation to be used.
preview_filesREQUIRED List of image links. These image links must show product with designs representing how the product should look after printing. There can be images from different angles.
print_filesREQUIRED List of print image links. These links will contain print files to be used for printing purposes. These print files are tailored for the respective printing process. If there are multiple areas to be printed there will be multiple print files.
quantityREQUIRED Represents the amount of items to be printed with this design.
Order tags
Represents additional order options passed to manufacturer. Currently, supported values below. List of supported tags could be extended.
sample Indicating if this is a sample order.
This field appears only in the request body of the POST/v2019-06/facilities/{FACILITY-ID}/orders.json
reprint Indicating if this is a reprint order.
This field appears only in the request body of the POST/v2019-06/facilities/{FACILITY-ID}/orders.json
prioritised Indicating if this is a prioritised order.
Endpoints
POST/v2019-06/orders.json
Submit a production order
The ID represents a unique identifier. You must reject duplicate submissions with 409 Conflict HTTP status code, see example below
If input data is not valid you must explicitly return an error message for each issue group type with 422 Unprocessable Entity HTTP status code, see examples below
POST/v2019-06/orders.json
{“id”: “5cb87a8cd490a2ccb256cec4”, “tags”: [“prioritised”], “sample”: “false”, “xqc”: “false”, “reprint”: “false”, “address_to”: {“address1”: “1234 address1 line”, “address2”: “ ”, “city”: “EXAMPLE”, “zip”: “31345”, “country”: “US”, “region”: “NY”, “first_name”: “john”, “last_name”: “smith”, “email”: “john.smith@example.com”, “phone”: “3312312231”}, “address_from”: {“address1”: “1234 address1 line”, “address2”: “ ”, “city”: “EXAMPLE”, “zip”: “31345”, “country”: “US”, “region”: “NY”, “company”: “T-Shirt Company #1”, “email”: “company@example.com”, “phone”: “6512312231”}, “shipping”: {“carrier”: “UPS”, “priority”: “express”}, “package_inserts”: [{“url”: “https://images.printify.com/storage/package-insert-1.pdf”}, {“url”: “https://images.printify.com/storage/package-insert-2.pdf”}], “items”: [{“id”: “62990bebad471213f4276ab5”, “sku”: “3001-BLACK-L”, “preview_files”: {“front”: “https://images.printify.com/mockup/front-url.jpeg”, “back”: “https://images.printify.com/mockup/back-url.jpeg”}, “print_files”: {“front”: “https://images.printify.com/print/front-url.jpeg”, “back”: “https://images.printify.com/print/back-url.jpeg”, “left_sleeve”: “https://images.printify.com/print/left_sleeve-url.jpeg”}, “quantity”: 1}, {“id”: “6299c9aa18b4f73df073095a”, “sku”: “3000-RED-L”, “preview_files”: {“front”: “https://images.printify.com/mockup/front-url.jpeg”, “back”: “https://images.printify.com/mockup/back-url.jpeg”}, “print_files”: {“front”: “https://images.printify.com/print/front-url.jpeg”}, “quantity”: 1}]}
View expected successful response (HTTP 201 Created) {“reference_id”: “{Your unique system order id}”}
View expected failed response (HTTP 409 Conflict)-duplicate in submitted order {“errors”: [{“type”: “other”, “message”: “Order with ID ‘5cb87a8cd490a2ccb256cec4’ already exists”}]}
View expected failed response (HTTP 422 Unprocessable Entity) (example 1-address_to, shipping, package_inserts) {“errors”: [{“type”: “address_to”, “message”: “Zip ‘19801’ is invalid for provided address”}, {“type”: “shipping”, “message”: “Carrier ‘DHL’ is not supported with priority express”}, {“type”: “package_inserts”, “message”: “Package insert ‘https://images.printify.com/storage/package-insert-1.pdf’ is of unsupported type”}]}
View expected failed response (HTTP 422 Unprocessable Entity) (example 2-out of stock item) {“errors”: [{“type”: “items”, “message”: “Item with SKU ‘SKU_A’ is out of stock at the provided facility: {FACILITY-ID}”}]}
Expected values of type field:
tags
address_to
address_from
shipping
package_inserts
items
other
POST/v2019-06/facilities/{FACILITY-ID}/orders.json
Submit production order to the facility
This API is used to directly place an order to a specific facility.
The ID represents a unique identifier. You must reject duplicate submissions with 409 Conflict HTTP status code, see example below
If input data is not valid you must explicitly return an error message for each issue group type with 422 Unprocessable Entity HTTP status code, see examples below
Facilities with their identifications (FACILITY-ID) are set up during the onboarding process. FACILITY-ID is alphanumeric identifier in UPPER case provided by Print Provider. Regexp pattern [A-Z0-9]+, example TEXAS2.
POST/v2019-06/facilities/{FACILITY-ID}/orders.json
{“id”: “5cb87a8cd490a2ccb256cec4”, “tags”: [“prioritised”, “sample”, “reprint”], “address_to”: {“address1”: “108 West 13th Street”, “city”: “Wilmington”, “zip”: “19801”, “country”: “US”, “region”: “DE”, “first_name”: “John”, “last_name”: “Smith”, “email”: “press@printify.com”, “phone”: “3312312231”}, “address_from”: {“address1”: “108 West 13th Street”, “city”: “Wilmington”, “zip”: “19801”, “country”: “US”, “region”: “DE”, “company”: “Hub Inc”, “email”: “press@printify.com”, “phone”: “6512312231”}, “shipping”: {“carrier”: “UPS”, “priority”: “express”}, “package_inserts”: [{“url”: “https://images.printify.com/storage/package-insert-1.pdf”}, {“url”: “https://images.printify.com/storage/package-insert-2.pdf”}], “items”: [{“id”: “6299c9b59abed8ddb15f2a76”, “sku”: “3001-BLACK-L”, “preview_files”: {“front”: “https://images.printify.com/mockup/front-url.jpeg”, “back”: “https://images.printify.com/mockup/back-url.jpeg”}, “print_files”: {“front”: “https://images.printify.com/print/front-url.jpeg”, “back”: “https://images.printify.com/print/back-url.jpeg”, “left_sleeve”: “https://images.printify.com/print/left_sleeve-url.jpeg”}, “quantity”: 1}]}
View expected successful response (HTTP 201 Created) {“reference_id”: “{Your unique system order ID}”}
View expected failed response (HTTP 404 Not Found) (example—when FACILITY-ID is invalid) {“errors”: [{“type”: “facility_id”, “message”: “Specified facility {FACILITY-ID} is invalid”}]}
View expected failed response (HTTP 409 Conflict)-duplicate in submitted order {“errors”: [{“type”: “other”, “message”: “Order with ID ‘5cb87a8cd490a2ccb256cec4’ already exists”}]}
View expected failed response (HTTP 422 Unprocessable Entity) (example 1-address_to, shipping, package_inserts) {“errors”: [{“type”: “address_to”, “message”: “Zip ‘19801’ is invalid for provided address”}, {“type”: “shipping”, “message”: “Carrier ‘DHL’ is not supported with priority express”}, {“type”: “package_inserts”, “message”: “Package insert ‘https://images.printify.com/storage/package-insert-1.pdf’ is of unsupported type”}]}
View expected failed response (HTTP 422 Unprocessable Entity) (example 2-out of stock item) {“errors”: [{“type”: “items”, “message”: “Item with SKU ‘SKU_A’ is out of stock at the provided facility: {FACILITY-ID}”}]}
Expected values of type field:
tags
address_to
address_from
shipping
package_inserts
items
other
GET/v2019-06/orders/{HUB-ID}.json
Retrieve a production order
GET/v2019-06/orders/{HUB-ID}.json
View expected response {“id”: “5cb87a8cd490a2ccb256cec4”, “reference_id”: “{Your system order ID}”, “tags”: [“prioritised”], “sample”: “false”, “xqc”: “false”, “reprint”: “false”, “address_to”: {“address1”: “1234 address1 line”, “address2”: “ ”, “city”: “EXAMPLE”, “zip”: “31345”, “country”: “US”, “region”: “NY”, “first_name”: “john”, “last_name”: “smith”, “email”: “john.smith@example.com”, “phone”: “3312312231”}, “address_from”: {“address1”: “1234 address1 line”, “address2”: “ ”, “city”: “EXAMPLE”, “zip”: “31345”, “country”: “US”, “region”: “NY”, “company”: “T-Shirt Company #1”, “email”: “company@example.com”, “phone”: “6512312231”}, “shipping”: {“carrier”: “UPS”, “priority”: “express”}, “package_inserts”: [{“url”: “https://images.printify.com/storage/package-insert-1.pdf”}, {“url”: “https://images.printify.com/storage/package-insert-2.pdf”}], “items”: [{“id”: “6299c9c5e328bef16c750a9d”, “sku”: “3001-BLACK-L”, “preview_files”: {“front”: “https://images.printify.com/mockup/front-url.jpeg”, “back”: “https://images.printify.com/mockup/back-url.jpeg”}, “print_files”: {“front”: “https://images.printify.com/print/front-url.jpeg”, “back”: “https://images.printify.com/print/back-url.jpeg”, “left_sleeve”: “https://images.printify.com/print/left_sleeve-url.jpeg”}, “quantity”: 1}, {“id”: “6299c9d14e285c40b9a62a4f”, “sku”: “3000-RED-

1. A computer-implemented method for use in a system including a plurality of merchants, a hub entity, a plurality of print providers, and a plurality of end customers, the computer-implemented method comprising:
a) receiving, by the hub entity directly or indirectly from one of the plurality of merchants, (1) an identifier of one of the plurality of print providers, (2) a product identifier, (3) a graphic design, and (4) a note design;
b) receiving, by the hub entity, directly or indirectly from one of the plurality of end users, an order for a product identified by the product identifier and including the graphic design;
c) transmitting, from the hub entity directly or indirectly to the one of the plurality of print providers, a printed product order including (1) the product identifier, (2) the graphic design or a unique identifier thereof, and (3) the note design or a unique identifier thereof;
d) printing, by the one of the plurality of print providers,
1) using a first printer, the graphic design on a product identified by the product identifier, to generate a printed product,
2) using a second printer, shipping information associated with the one of the plurality of end users, to generate a printed shipping label, and
3) using a third printer or a different paper source of the second printer, a note using the note design, to generate a printed note; and
e) packaging the printed product and the printed note, thereby defining a packed package,
wherein the shipping label is printed on, or affixed to, the packed package.

2. The computer-implemented method of claim 1, further comprising:
f) initiating shipping to the end customer the packed package.

3. The computer-implemented method of claim 1, wherein the printed note includes a QR code to allow user to (A) leave a review, (B) leave a rating, (C) request a refund, (D) request a return, and/or (E) request a reprint.

4. The computer-implemented method of claim 1, wherein the printed note includes a name of the end customer to whom the package is being shipped.

5. The computer-implemented method of claim 1, wherein the printed note includes at least one element customized based on a geographic area of end customer to whom the package is being shipped.

6. The computer-implemented method of claim 1, wherein the printed note includes a voucher.

7. The computer-implemented method of claim 6, wherein a value or amount of the voucher is determined dynamically.

8. A computer-implemented method for use in a system including a plurality of merchants, a hub entity, a plurality of print providers, and a plurality of end customer, the computer-implemented method comprising:
a) receiving, by the hub entity directly or indirectly from one of the plurality of merchants, (1) an identifier of one of the plurality of print providers, (2) a product identifier, (3) a graphic design, and (4) a note design;
b) receiving, by the one of the plurality of print providers, a printed product order including (1) the product identifier, (2) the graphic design or a unique identifier thereof, and (3) the note design or a unique identifier thereof;
c) printing, by the one of the plurality of print providers and using a first printer, the graphic design on a product identified by the product identifier, to generate a printed product; and
d) printing, by the one of the plurality of print providers and responsive to receiving a single a trigger signal
1) using a second printer, shipping information associated with the one of the plurality of end users, to generate a printed shipping label, and
2) using a third printer or a different paper source of the second printer, a note using the note design, to generate a printed note.

9. The computer-implemented method of claim 8, further comprising:
e) packaging the printed product and the printed note, thereby defining a packed package, wherein the shipping label is printed on, or affixed to, the packed package.

10. The computer-implemented method of claim 9, further comprising:
f) initiating shipping the packed package.

11. The computer-implemented method of claim 8, wherein the printed note includes a QR code to allow user to (A) leave a review, (B) leave a rating, (C) request a refund, (D) request a return, and/or (E) request a reprint.

12. The computer-implemented method of claim 8, wherein the printed note includes a name of the end customer to whom the package is being shipped.

13. The computer-implemented method of claim 8, wherein the printed note includes at least one element customized based on a geographic area of end customer to whom the package is being shipped.

14. The computer-implemented method of claim 8, wherein the printed note includes a voucher.

15. The computer-implemented method of claim 14, wherein a value or amount of the voucher is determined dynamically.

16. The computer-implemented method of claim 13, wherein the single trigger signal is receipt of a scanned code associated with the printed product.

17. The computer-implemented method of claim 13, wherein the single trigger signal is invoked responsive to the printing, by the one of the plurality of print providers and using a first printer, of the graphic design on a product identified by the product identifier.

18. The computer-implemented method of claim 13, wherein each of the shipping label and note include a matching rare design to enable them to be matched using a visual inspection.

19. The computer-implemented method of claim 18 wherein the matching rare design includes a thumbnail of printed product.

20. The computer-implemented method of claim 18 wherein the matching rare design includes at least one colored symbol.

21. (canceled)

22. A non-transitory computer-readable medium storing processor-executable instructions which, when executed by at least one processor, cause the at least one processor to perform a method for use in a system including a plurality of merchants, a hub entity, a plurality of print providers, and a plurality of end customers, the method comprising:
a) receiving, by the hub entity directly or indirectly from one of the plurality of merchants, (1) an identifier of one of the plurality of print providers, (2) a product identifier, (3) a graphic design, and (4) a note design;
b) receiving, by the hub entity, directly or indirectly from one of the plurality of end users, an order for a product identified by the product identifier and including the graphic design;
c) transmitting, from the hub entity directly or indirectly to the one of the plurality of print providers, a printed product order including (1) the product identifier, (2) the graphic design or a unique identifier thereof, and (3) the note design or a unique identifier thereof;
d) printing, by the one of the plurality of print providers,
1) using a first printer, the graphic design on a product identified by the product identifier, to generate a printed product,
2) using a second printer, shipping information associated with the one of the plurality of end users, to generate a printed shipping label, and
3) using a third printer or a different paper source of the second printer, a note using the note design, to generate a printed note; and
e) packaging the printed product and the printed note, thereby defining a packed package,
wherein the shipping label is printed on, or affixed to, the packed package.
